(19) United States
(12) Patent Application Publication
(10) Pub. No.: US 2005/0033206 A1
(43) Pub. Date: Feb. 10, 2005

(54) Multi-purpose soft massag bath board structure

(76) Inventor: Kun-Ching Yeh, Taichung-City (TW)

Correspondence Address: RABIN & BERDO, P.C., Suite 500, 1101 14th Street, N.W., Washington, DC, 20005, US

(21) Appl. No.: 10/636,587

(22) Filed: Aug. 8, 2003

(51) Int. Cl. A61H 9/00

(52) U.S. Cl. 601/158

(57) ABSTRACT

A multi-purpose soft massage bath board constructed of a plaint plastic material and having a plurality of short projections arrayed on its two surfaces along with a plurality of holes and, the short projections along the two sides are taller such that the crosswise formation of the short projections is arcuate, and a plane is disposed at the front and rear end. When the user manually grasps the massage bath board and strokes the plurality of short projections on its two surfaces against the skin, the present invention massages and cleanses. The board of supports the placement of a bar of soap, the holes providing ventilation that maintains dryness. It can even be folded over and the planes at the front and rear end held with the fingers to utilize the numerous short projections for exfoliating the back of the body. As such, the invention herein achieves multi-purpose capability.

### BACKGROUND OF THE INVENTION

1) Field of the Invention

The invention herein relates to personal grooming accessories, specifically a multi-purpose soft massage bath board structure constructed of a plaint plastic material having a plurality of short projections arrayed on its two surfaces along with a plurality of holes and, furthermore, the short projections along the two sides are taller such that the crosswise formation of the short projections is arcuate, and a plane is disposed at the front and rear end; as such, the present invention provides for massaging, cleansing, object drying, and exfoliation to thereby achieve multi-purpose capability.

2) Description of the Prior Art

The overwhelming majority of conventional bath balls used for bathing are plastic netting wrapped into a sphere such that after saturation with liquid soap they are used to scrub the skin of the body. However, since the layered plastic netting constituting them is originally flat, the said bath balls are only capable of scrubbing and unable to provide for other applications. In most bathrooms, soap bars, sponge balls, and other items are usually placed in containers to separate them from wet shelf surfaces and thereby prevent softening and slipperiness due to prolonged water immersion. In actual practice, however, when a bar of soap is placed in a container by hand, water in the suds runs off into the container, and the since the container lacks vent holes or has clogged vent holes, the said bar of soap becomes soft and slippery in the pooled water because drying is not possible.

Additionally, conventional exfoliating boards currently in use are typically fabricated of ox horn or a hard plastic material. Since the said exfoliating boards are stiff and used to scratch the back of the body, excessive usage often results in a painful feeling. Although effective to a degree, such products are not entirely practical.

In view of the said situation, the applicant of the invention herein addressed the inconvenient aspects of the said conventional products by seeking improvements, culminating in the successful development of the invention herein which is submitted in application for the commensurate patent rights.

### SUMMARY OF THE INVENTION

The primary objective of the invention herein is to provide a multi-purpose soft massage bath board, the said massage bath board constructed of a plaint plastic material having a plurality of short projections arrayed on its two surfaces along with a plurality of holes and, furthermore, the short projections along the two sides are taller such that the crosswise formation of the short projections is arcuate, and a plane is disposed at the front and rear end; as such, when the user manually grasps the said massage bath board and strokes the plurality of short projections on its two surfaces against the skin, the present invention massages and cleanses.

Another objective of the invention herein is to provide a multi-purpose soft massage bath board, wherein the said massage bath board utilizes the plurality of short projections arrayed on its two surfaces along with a plurality of holes and, furthermore, the short projections along the two sides are taller such that the crosswise formation of the short projections is arcuate and when a bar of soap is place thereon, dryness is effectively maintained.

Yet another objective of the invention herein is to provide a multi-purpose soft massage bath board, the said massage bath board constructed of a plaint plastic material having a plurality of short projections arrayed on its two surfaces along with a plurality of holes and, furthermore, the short projections along the two sides are taller such that the crosswise formation of the short projections is arcuate, and a plane is disposed at the front and rear end, enabling the user to fold the massage bath board, hold it by the planes at the front and the rear end with the fingers, and thereby stroke the numerous soft short projections to and fro against the back for exfoliating purposes.

### BRIEF DESCRIPTION OF THE DRAWINGS

FIG. 1 is an isometric drawing of the invention herein.

FIG. 2-A is a cross-sectional drawing (1) of the invention herein.

FIG. 2-B is a cross-sectional drawing (2) of the invention herein.

FIG. 3 is an illustration of an embodiment (1) of the invention herein.

FIG. 4 is an illustration of an embodiment (2) of the invention herein.

FIG. 5 is a cross-sectional drawing of an embodiment (3) of the invention herein.

FIG. 6 is an illustration of an embodiment (4) of the invention herein.

### DETAILED DESCRIPTION OF THE INVENTION

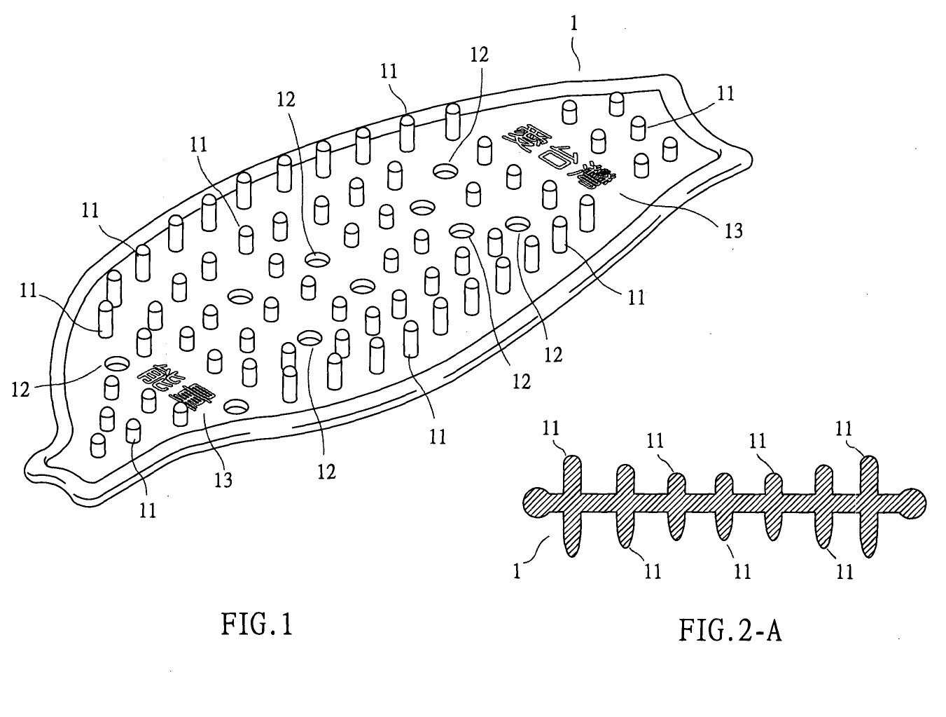

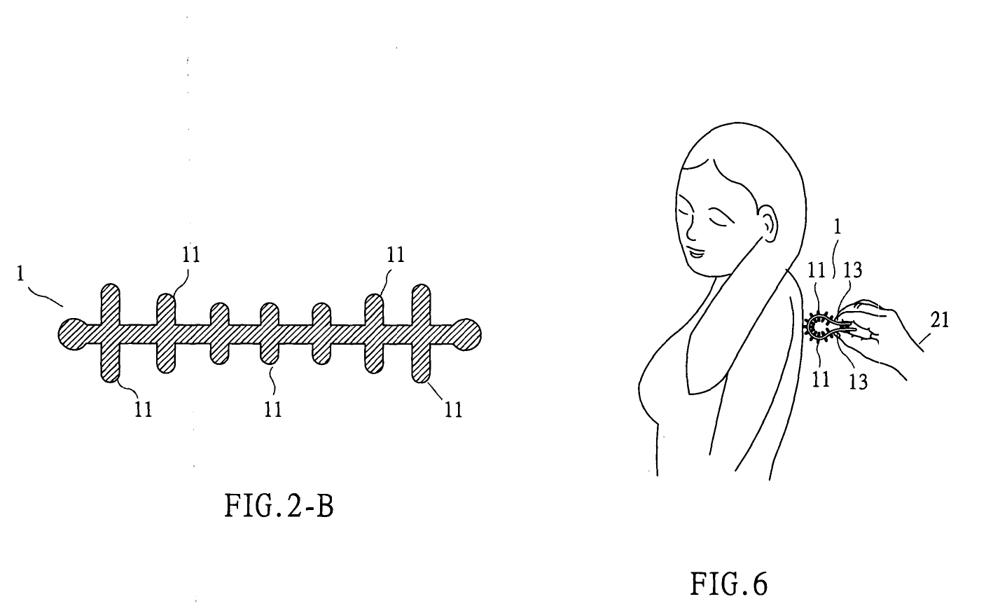

Referring to FIG. 1 and FIG. 2, the multi-purpose soft massage bath board structure of the invention herein, the said massage bath board 1 is constructed of a pliant plastic material shaped like Taiwan or other form having a plurality of short projections 11 arrayed on its two surfaces along with a plurality of holes 12, wherein the tips of the numerous short projections 11 are divided into profiles that are blunter and sharper (as shown in FIG. 2-A) or unique (as shown in FIG. 2-B) and, furthermore, the short projections 11 along the two sides are taller such that the crosswise formation of the short projections is arcuate, and a plane 13 is disposed at the front and rear end.

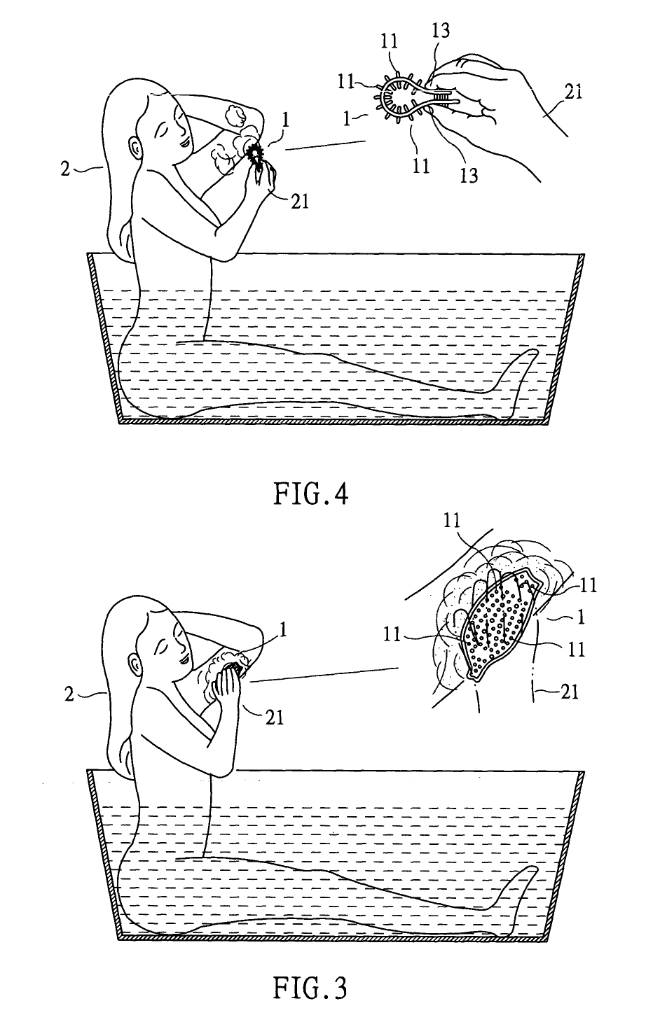

As such, since the said massage bath board 1 is of pliant plastic construction, it is lightweight and easy to handle such that when the user 2 manually grasps the said massage bath board 1 and strokes the plurality of short projections 11 saturated with a soap solution against the skin, a massage effect is produced at the same time, as indicated in FIG. 3; furthermore, the user 2 can turn the massage bath board 1 around to select the sharper or blunter short projections 11; or, the user 2 can fold the massage bath board I and hold the planes 13 at the front and rear end with the fingers 21 to thereby utilize the plurality of short projections 11 to scrub while also massaging and cleansing various sections of the body, as shown in FIG. 4.

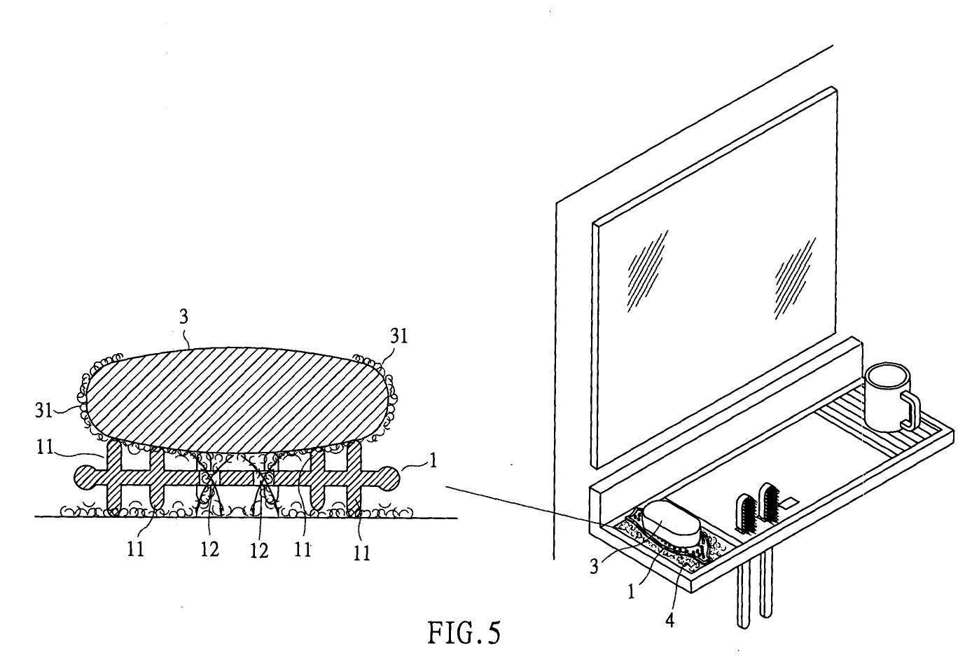

Additionally, the said massage bath board 1 serves as an object placement plate in that a bar of soap 3 can be situated on the massage bath board 1; since the numerous short projections 11 arrayed on the two surfaces of the massage bath board 1 affords separation from the drip shelf 4 and are taller along the two sides of the massage bath board 1 such that the crosswise formation of short projections is arcuate, suds 31 on the bar of soap 3 gradually drip from the bar of soap 3 and flow through the holes 12 among the numerous short projections 11 onto the shelf 4, as shown in FIG. 5, thereby preventing the softening of the bar of soap 3. If a shaving razor, tooth brush, sponge, or other object was placed thereon, this would also promote dryness by allowing moisture displacement.

Additionally, the pliant material construction of the said massage bath board 1 is utilized such that after it is folded and held by the planes 13 at the front and rear end with the fingers 21, the numerous short projections 11 are at maximum extension and the massage bath board 1 can be articulated to and fro against the back of another person, as shown in FIG. 6; of course, the surface can be reversed to select sharper or blunter short projections 11 for exfoliation usage; since the short projections 11 along the two sides of the massage bath board 1 are taller such that the crosswise formation is arcuate and, furthermore, have pliant properties, they are not overly stiff and painful as conventional exfoliating boards during exfoliation, but provide a feeling that is “firm, not too rigid” or “soft but resilient” without a loss of effectiveness; as such, the invention herein minimizes pain and apprehension when utilized for exfoliation.

In summation of the foregoing section, since the invention herein is multi-purpose and progressive in capability and, furthermore, complies with Article 97 of the New Patent Law, the present invention is submitted to the patent bureau for review and the granting of the commensurate patent rights.

1. A multi-purpose soft massage bath board, the said massage bath board constructed of a plaint plastic material and having a plurality of short projections arrayed on its two surfaces along with a plurality of holes and, furthermore, the said short projections along the two sides are taller such that the crosswise formation of the said short projections is arcuate, and a plane is disposed at the front and rear end; when the user manually grasps the said massage bath board and strokes the plurality of said short projections on its two surfaces against the skin, the present invention massages, cleanses, and exfoliates and, furthermore, maintains the dryness of objects placed on it, thereby achieving multi-purpose capability.
